(19) United States
(12) Patent Application Publication
(10) Pub. No.: US 2016/0232463 A1
(43) Pub. Date: Aug. 11, 2016

(54) GENERATING AND EXECUTING COMPUTER SYSTEM WORKFLOW ACTION ITEMS BASED UPON ANALYSIS OF CUSTOMER SOCIAL MEDIA ACTIVITY

(71) Applicants: John C. McDonough, Nahant, MA (US); Ashley Marie Reichert, Boston, MA (US); Andrew Jason Seelig, Lafayette, NJ (US)

(72) Inventors: John C. McDonough, Nahant, MA (US); Ashley Marie Reichert, Boston, MA (US); Andrew Jason Seelig, Lafayette, NJ (US)

(21) Appl. No.: 14/615,453

(22) Filed: Feb. 6, 2015

(51) Int. Cl. G06Q 10/06; G06Q 50/00

(52) U.S. Cl. CPC G06Q 10/0633; G06Q 50/01

(57) ABSTRACT

Methods and apparatuses are described for generating and executing computer system workflow action items based upon analysis of customer social media activity. A social media processing engine receives social media activity data from each of a plurality of social media data sources and identifies a customer associated with the social media activity data. The social media processing engine selects a workflow action item based upon the portion of the social media activity data and retrieves customer profile data and customer account data for the workflow action item. The social media processing engine populates the workflow action item with the customer profile data and the customer account data and transmits the populated workflow action item to a workflow processing engine, which executes the populated workflow action item to transmit a workflow transaction request to an enterprise computing system that is responsive to the workflow action item.

### TECHNICAL FIELD

This application relates generally to methods and apparatuses, including computer program products, for generating and executing computer system workflow action items based upon analysis of customer social media activity.

### BACKGROUND

Social media platforms have become repositories for a wealth of information relating to customers and potential customers of organizations. Analysis of the social media activity data contained within the social media platforms is important for an organization to better understand its customers' needs and to proactively provide customer engagement opportunities and execute transaction workflows in response to customer activity on social media.

However, it is challenging to obtain relevant social media data and convert the data into actionable workflow items, where the workflow items automatically initiate computerized transaction workflows among various enterprise computing systems to provide transaction results that respond to or anticipate customer needs in view of the social media data. Current systems lack a methodology to seamlessly and quickly synthesize customer-specific social media data to initiate data-related transactions across an organization's computing systems.

### SUMMARY

Therefore, what is needed is a method and system to analyze and extract meaningful customer-related content information from a variety of social media sources and translate the social media activity data into workflow action items that can be executed to initiate transactions that are responsive to the social media activity data. The techniques described herein provide the advantage of dynamically analyzing social media activity data to generate computer system workflow action items based upon needs identified in the social media activity data and/or matches to content characteristics of the social media activity data. The techniques described herein further provide the advantage of automatically executing the workflow action items to generate requests to enterprise computing systems that can perform transaction workflows in response to the workflow action item and achieve a result that engenders further customer service opportunities and customer contact interactions.

The invention, in one aspect, features a computerized method for generating and executing computer system workflow action items based upon analysis of customer social media activity. A social media processing engine receives social media activity data from each of a plurality of social media data sources and identifies a customer associated with a portion of the social media activity data. The social media processing engine selects a workflow action item based upon the portion of the social media activity data for the identified customer and retrieves customer profile data and customer account data for the workflow action item based upon the identified customer. The social media processing engine populates the workflow action item with the customer profile data and the customer account data and transmits the populated workflow action item to a workflow processing engine. The workflow processing engine executes the populated workflow action item to transmit a workflow transaction request to an enterprise computing system that is responsive to the workflow action item.

The invention, in another aspect, features a system for generating and executing computer system workflow action items based upon analysis of customer social media activity. The system comprises a social media processing engine of a server computing device. The social media processing engine is configured to receive social media activity data from each of a plurality of social media data sources and identify a customer associated with a portion of the social media activity data. The social media processing engine is configured to select a workflow action item based upon the portion of the social media activity data for the identified customer, retrieve customer profile data and customer account data for the workflow action item based upon the identified customer, and populate the workflow action item with the customer profile data and the customer account data. The system further comprises a workflow processing engine of a server computing device, the workflow processing engine being coupled to the social media processing engine. The workflow processing engine is configured to receive the populated workflow action item from the social media processing engine and execute the populated workflow action item to transmit a workflow transaction request to an enterprise computing system that is responsive to the workflow action item.

The invention, in another aspect, features a computer program product, tangibly embodied in a non-transitory computer readable storage device, for generating and executing computer system workflow action items based upon analysis of customer social media activity. The computer program product comprises instructions operable to cause a social media processing engine of a server computing device to receive social media activity data from each of a plurality of social media data sources and identify a customer associated with a portion of the social media activity data. The computer program product comprises instructions operable to cause the social media processing engine to select a workflow action item based upon the portion of the social media activity data for the identified customer, retrieve customer profile data and customer account data for the workflow action item based upon the identified customer, and populate the workflow action item with the customer profile data and the customer account data. The computer program product comprises instructions operable to cause a workflow processing engine of a server computing device coupled to the social media processing engine to receive the populated workflow action item from the social media processing engine and execute the populated workflow action item to transmit a workflow transaction request to an enterprise computing system that is responsive to the workflow action item.

Any of the above aspects can include one or more of the following features. In some embodiments, the social media activity data is received via an application programming interface (API) between the social media processing engine and a social media data source. In some embodiments, selecting a workflow action item based upon the portion of the social media activity data for the identified customer comprises analyzing the portion of the social media activity data for the identified customer to extract a plurality of content characteristics associated with the social media activity data, and selecting a workflow action item based upon the extracted content characteristics. In some embodiments, the plurality of content characteristics includes sentiment data, financial data, employment data, life event data, audiovisual data, search engine query data, customer relationship management (CRM) data, and real estate data.

In some embodiments, the social media processing engine determines a plurality of potential workflow action items based upon the extracted content characteristics and selects a workflow action item that best matches the extracted content characteristics. In some embodiments, the social media processing engine determines a customer need based upon the extracted content characteristics and selects a workflow action item that addresses the customer need.

In some embodiments, the enterprise computing system receives the transaction workflow request and initiates a transaction workflow based upon the received request. In some embodiments, the social media processing engine selects a plurality of workflow action items based upon the portion of the social media activity data for the identified customer.

In some embodiments, executing the populated workflow action item comprises identifying an enterprise computing system that is capable of processing the workflow action item, and translating the workflow action item into the workflow transaction request based upon data requirements associated with the enterprise computing system. In some embodiments, the workflow transaction request comprises programmatic instructions specific to the corresponding enterprise computing system that, when executed by the enterprise computing system, initiates the workflow transaction.

In some embodiments, the workflow processing engine generates a report associated with the received workflow action item and transmits the report to a remote client device for display. In some embodiments, the report comprises an alert to a customer service representative to take an action based upon the workflow action item.

In some embodiments, identifying a customer associated with a portion of the social media activity data comprises determining a social media account name contained in the portion of the social media activity data, and linking the social media account name to a customer identity using a customer profile database. In some embodiments, the social media account name is provided by the customer when establishing a customer profile associated with the customer.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for generating and executing computer system workflow action items based upon analysis of customer social media activity.

FIG. 2 is a flow diagram of a method for generating and executing computer system workflow action items based upon analysis of customer social media activity.

FIG. 3 is a block diagram of a system for generating and executing customer service management and account trading transaction workflow action items based upon analysis of customer social media activity.

FIG. 4 is a block diagram of a system for generating and executing customer service management and account security workflow action items based upon analysis of customer social media activity.

### DETAILED DESCRIPTION

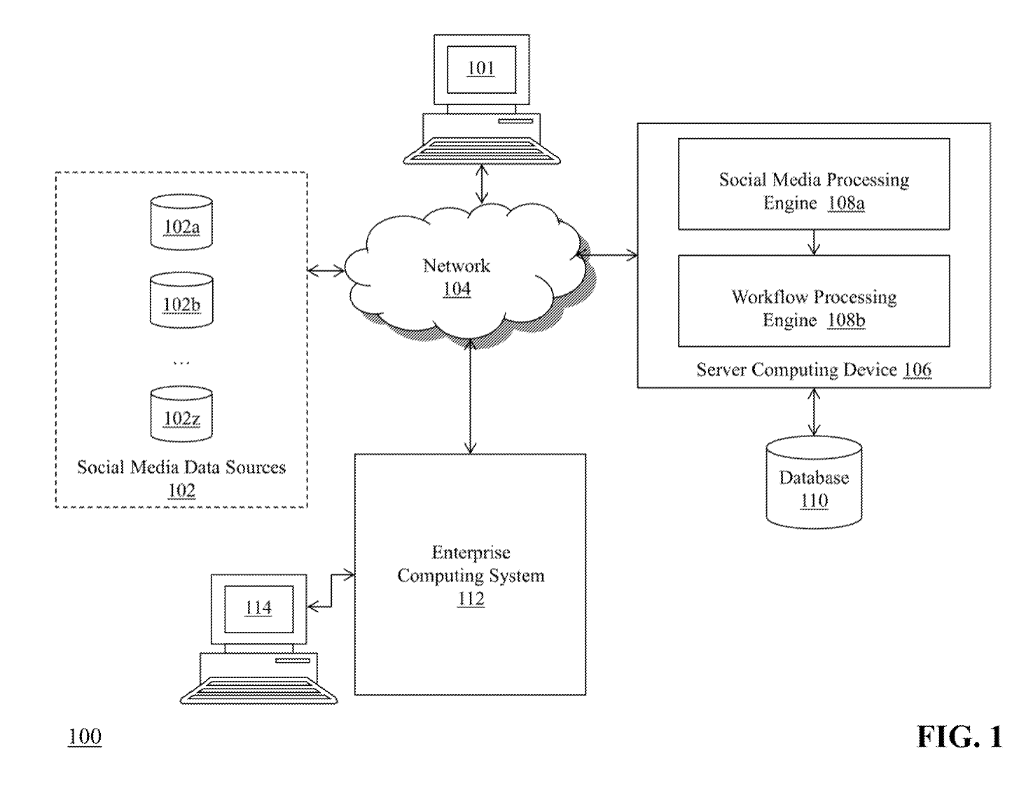

FIG. 1 is a block diagram of a system 100 for generating and executing computer system workflow action items based upon analysis of customer social media activity. The system 100 includes client devices 101, 114, a plurality of social media data sources 102a-102z (collectively, 102), a communications network 104, a server computing device 106 with social media processing engine 108a and a workflow processing engine 108b, a database 110, and an enterprise computing system 112.

The client device 101 connects to the communications network 104 in order to communicate with the other components in the system 100 to provide input and receive output relating to the process of generating and executing computer system workflow action items as described herein. For example, client device 101 can be associated with a customer of an organization (e.g., a corporation) and the customer can use client device 101 to access social media platforms from which the social media activity data is sourced. A social media platform can be a website or other data repository where users can perform particular social activities, such as creating and managing a customized user profile, posting status messages, making connections to other users, adding life status and/or employment status events, sharing media (e.g., video content or image content), inputting search queries to retrieve information, and so forth. Such social activities are captured by the social media platforms as social media activity data, which can then be made available as a data feed to other computing devices, e.g., via Application Programming Interface (API). It can be appreciated that activity data from a wide variety of social media platforms can be leveraged in the context of the system 100. Example social media platforms include Facebook™, Twitter™, YouTube™, Linkedln™, Instagram™, Google™ Search, and Zillow™.

The client device 114 connects to the enterprise computing system 112 in order to provide input and receive output relating to the process of generating and executing computer system workflow action items as described herein. For example, client device 114 can be associated with an employee, representative, or associate of the organization mentioned above. The employee can receive alerts, reports, and other workflow action items from the enterprise computing system 112 via client device 114—as will be described in greater detail below.

Exemplary client devices 101, 114 include desktop computers, laptop computers, tablets, mobile devices, smartphones, connected cars (e.g., via WiFi, Bluetooth, etc.) having associated computing devices inside the car (such as a smart entertainment system), and internet appliances. It should be appreciated that other types of computing devices that are capable of connecting to the components of the system 100 can be used without departing from the scope of invention. Although FIG. 1 depicts two client devices 101, 114, it should be appreciated that the system 100 can include any number of client devices. In some embodiments, the client devices 101, 114 also include a display for receiving data from the other components of the system 100 and displaying the data to a user of the client devices 101, 114.

The social media data sources 102 transmit social media activity data to the social media processing engine 108a of the server computing device 106. As mentioned above, the social media activity data is generated by customers of an organization (e.g., a user of client device 101) performing social activities on social media platforms. The social media activity is captured by the respective platforms and then made available to the social media processing engine 108a. Exemplary methods that can be used by the social media processing engine 108a to obtain the social media activity data include, but are not limited to, APIs, subscription/ad-hoc data feeds, screen scraping, retrieval of metadata or tags associated with the social media activity data, and so forth. In some embodiments, the social media data sources 102 push the social media activity data to the social media processing engine 108a automatically or upon request by the social media processing engine 108a. In some embodiments, the social media processing engine 108a pulls the social media activity data from the social media data sources 102 automatically in real-time or at periodic intervals.

The communication network 104 enables the other components of the system 100 to communicate with each other in order to perform the process of generating and executing computer system workflow action items as described herein. The network 104 may be a local network, such as a LAN, or a wide area network, such as the Internet and/or a cellular network. In some embodiments, the network 104 is comprised of several discrete networks and/or sub-networks (e.g., cellular to Internet) that enable the components of the system 100 to communicate with each other.

The social media processing engine 108a of the server computing device 106 receives social media activity data from the plurality of data sources 102 for generation and execution of computer system workflow action items according to the methods described herein. The workflow processing engine 108b of the server computing device 106 receives workflow action items from the social media processing engine 108a and executes the workflow action items to transmit a workflow transaction request to other computing devices or systems (e.g., enterprise computing system 112) to initiate a workflow transaction in response to the transaction request. The social media processing engine 108a and the workflow processing engine 108b are specialized hardware and/or software modules executing within the server computing device 106 to perform the workflow action item generation and execution process described herein. Although the social media processing engine 108a and the workflow processing engine 108b are shown in FIG. 1 as executing within the same server computing device 106, in some embodiments the functionality of the social media processing engine 108a and the workflow processing engine 108b can be distributed among a plurality of server computing devices. It should be appreciated that any number of computing devices, arranged in a variety of architectures, resources, and configurations (e.g., cluster computing, virtual computing, cloud computing) can be used without departing from the scope of the invention. The exemplary functionality of the social media processing engine 108a and the workflow processing engine 108b will be described in detail below.

The system 100 also includes a database 110. The database 110 is coupled to the server computing device 106 and stores data used by the social media processing engine 108a and the workflow processing engine 108b to perform the workflow action item generation and execution process. The database 110 can be integrated with the server computing device 106 or be located on a separate computing device. An example database that can be used with the system 100 is MySQL™ available from Oracle Corp. of Redwood City, Calif.

The system 100 also includes an enterprise computing system 112. The enterprise computing system 112 comprises one or more computing devices configured to store data and perform workflow initiation and processing relating to one or more transactions (e.g., account transactions, customer relationship management transactions, marketing transactions) identified as being responsive to workflow action items generated by the workflow processing engine 108b based upon analysis of the social media activity data by the social media processing engine 108a, as mentioned above.

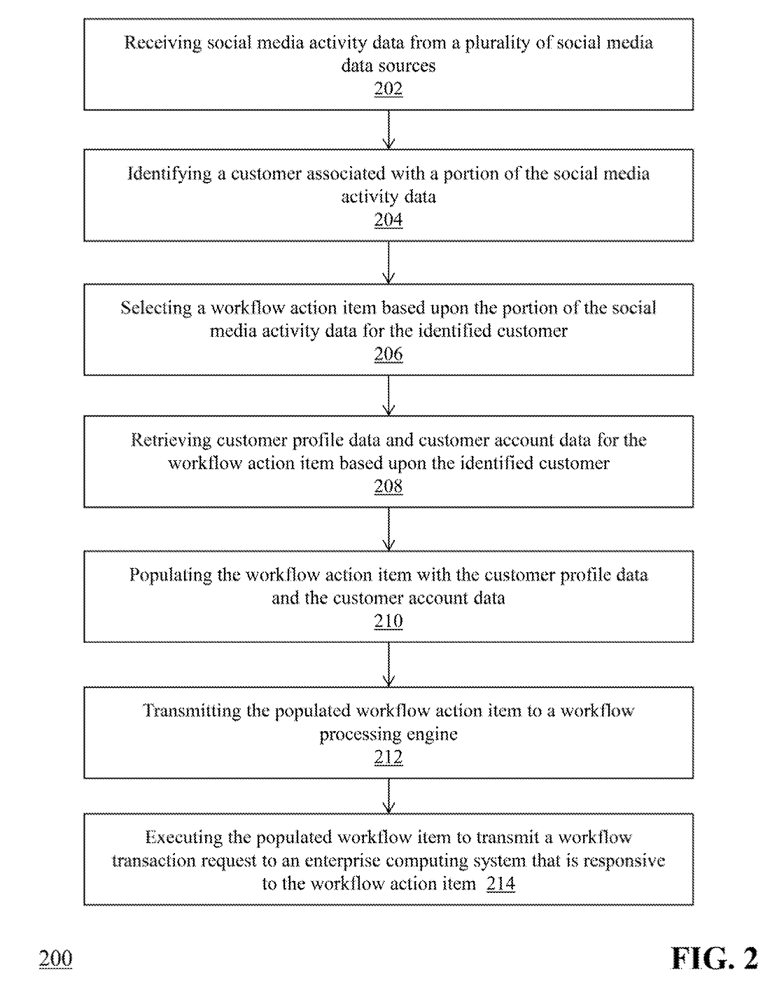

FIG. 2 is a flow diagram of a method 200 for generating and executing computer system workflow action items based upon analysis of customer social media activity, using the system 100 of FIG. 1. The social media processing engine 108a receives (202) social media activity data from a plurality of social media data sources 102. As described previously, the social media processing engine 108a can obtain social media activity data from a variety of social media platforms and data sources via different methods (API, scraping, subscription feeds, and the like).

The social media processing engine 108a identifies (204) a customer associated with a portion of the social media activity data. In some embodiments, the social media processing engine 108a can parse the social media activity data to identify social media account names that are associated with customers of the organization. For example, the customers may have previously provided their corresponding social media account names to the organization as part of, e.g., a customer intake form, a marketing inquiry, an account setup process, or other similar activities. In some cases, the customers may have authorized the organization to receive their social media activity data from the social media data sources 102.

In some embodiments, the social media processing engine 108a can analyze the social media data to identify demographic data for individuals and then associate the demographic data with a customer database to determine whether the identified individuals are customers of the organization. For example, the social media processing engine 108a can analyze the social media activity data to determine that Joe P. Smith from Richmond, Va., age forty-five, has recently made a series of status updates on his Facebook page. The social media processing engine 108a can compare this information against a customer profile database (e.g., database 110) and determine that the organization has a customer whose profile matches the characteristics extracted from the social media activity data.

The social media processing engine 108a selects (206) a workflow action item based upon the portion of the social media activity data for the identified customer. When the social media processing engine 108a has identified a customer associated with a portion of the social media data, the social media processing engine 108a can analyze the portion of the social media data to determine a plurality of content characteristics associated with the social media activity data. Exemplary content characteristics include, but are not limited to, sentiment data, financial data, employment data, life event data, audiovisual data, search engine query data, customer relationship management (CRM) data, and real estate data. For example, if a customer just updated his employment status on LinkedIn to indicate that he has changed jobs, and perhaps he has placed his home on the market (e.g., via information provided on Realtor.com or Zillow), the social media processing engine 108a can determine that the customer may wish to rollover his 401(k) account from his previous employer. As a result, the social media processing engine 108a can select a workflow action item associated with a particular workflow process to be initiated, where upon completion the workflow process would result in a response that addresses a customer need identified in the social media activity data by the engine 108a or best matches the content characteristics and thus results in an opportunity to initiate an interaction with the customer. Using the above 401(k) example, the engine 108a can select a workflow action item that would initiate a customer contact transaction (e.g., email, text message) via the organization's CRM system informing the customer of the rollover options available to him. The social media processing engine 108a can also select a workflow action item that would initiate a 401(k) account application transaction (e.g., pre-filling an electronic application form) via the organization's account creation and processing system that could be sent or linked to the customer to start an account creation process.

The social media processing engine 108a retrieves (208) customer profile data and customer account data for the workflow action item based upon the identified customer. Once the workflow action item is selected, the social media processing engine 108a determines whether the workflow action item requires any additional customer profile and/or customer account information to enable the workflow processing engine 108b to execute the workflow action item. For example, the workflow action item for a customer contact transaction may require that the customer's contact information (e.g., email address, phone number, mailing address, and the like) is populated. In another example, the workflow action item for a 401(k) account application transaction may require that the customer's social security number or bank account information is populated. The social media processing engine 108a can retrieve the required information for the workflow action item from a database (e.g., 110). The social media processing engine 108a populates (210) the workflow action item with the customer profile data and the customer account data retrieved from the database 110.

Once the workflow action item is populated, the social media processing engine 108a transmits (212) the populated workflow action item to the workflow processing engine 108b. The workflow processing engine 108b executes (214) the populated workflow action item to transmit a workflow transaction request to the enterprise computing system 112 that is responsive to the workflow action item. In some embodiments, the workflow processing engine 108b receives the populated workflow action item and identifies an enterprise computing system 112 that can be instructed to initiate a transaction that is responsive to the action item. For example, if the workflow action item is a customer contact transaction to inform the customer of his 401(k) account rollover options, the workflow processing engine 108b identifies that the organization's CRM system as being able to initiate a workflow to accomplish the customer contact transaction.

The workflow processing engine 108b can execute the workflow action item to result in the transmission of a workflow transaction request to the enterprise computing system 112. In some embodiments, as part of the execution of the workflow action item, the workflow processing engine 108b translates the workflow action item into the workflow transaction request based upon data requirements associated with the enterprise computing system. The workflow processing engine 108b can convert the action item from one data protocol to another data protocol that is accepted by the enterprise system 112 and/or the workflow processing engine 108b can format the data elements that comprise the workflow action item into a form that is acceptable by the enterprise system 112. It should be appreciated that other types of conversion or translation of the workflow action item to a form that is usable by the enterprise computing system 112 (e.g., encryption, data allocation, authentication) are within the scope of invention.

The enterprise computing system 112 receives the workflow transaction request and initiates a workflow process that is responsive to the request. For example, if the workflow action item is a customer contact transaction to inform the customer of his 401(k) account rollover options, the workflow transaction request can be specific instructions for the enterprise computing system 112 that cause the enterprise computing system 112 to perform particular actions to fulfill the transaction request (i.e., transmit an email/text message to the customer, pre-fill an account rollover application and mail to the customer, etc.).

The following are specific use cases embodying the system and method described above. It should be appreciated that other use cases can be contemplated within the scope of invention.

Use Case 1

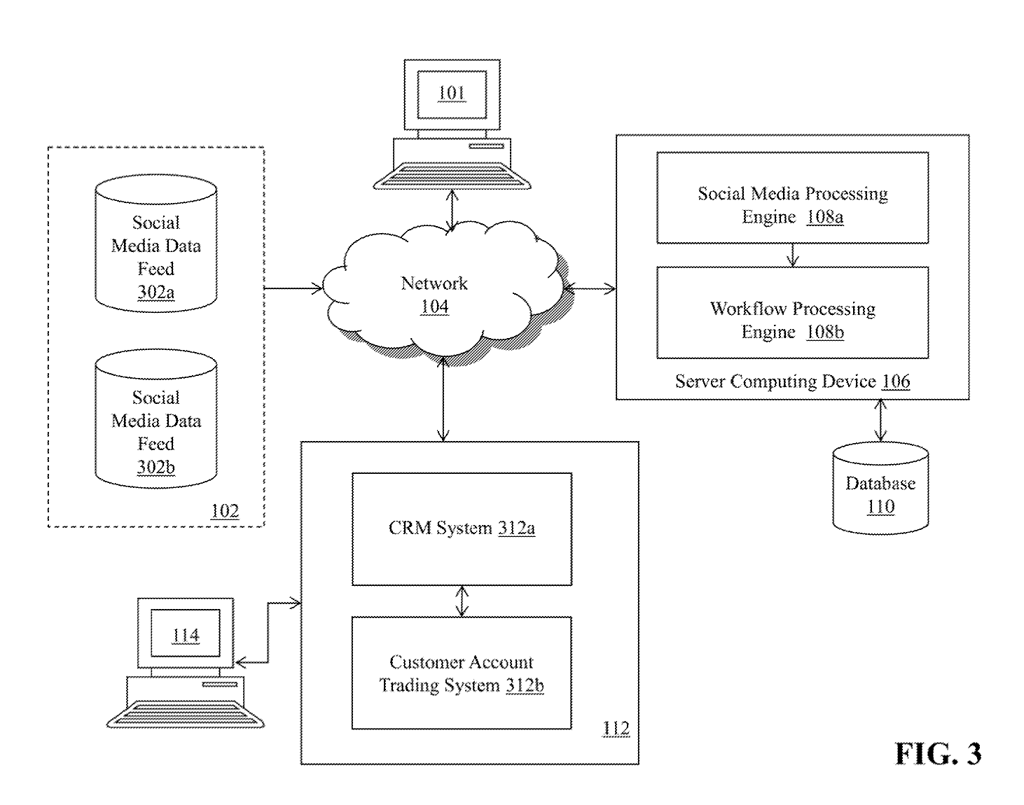

FIG. 3 is a block diagram of a system for generating and executing customer service management and account trading transaction workflow action items, based upon the system 100 of FIG. 1. In this use case, the customer at client device 101 has just posted a tweet via his Twitter account: “I really like my new Ford car.” The social media processing engine 108a receives the tweet via social media data feed 302a and parses the tweet to extract certain relevant information, such as the Twitter account name (e.g., @johndoe) and the text of the tweet.

In some embodiments, the customer may have previously provided his Twitter account name to the organization and linked the Twitter name to his customer profile at the organization. Therefore, the social media processing engine 108a retrieves the customer's account and profile information from database 110 using the Twitter account name.

In addition, the social media processing engine 108a analyzes the text of the tweet to obtain content characteristics. For example, the engine 108a assigns a positive sentiment score to the tweet based upon the use of the words “really like” in the message. The engine 108a extracts the words “Ford car” and retrieves the stock symbol for Ford Motor Company (‘F’). The engine 108a also retrieves customer account information from database 110 and determines that the customer currently has an investment portfolio account with the organization that regularly invests in U.S. auto companies but currently does not have any positions in Ford. The engine 108a also determines that the customer's account currently has $10,000 in cash and is underinvested in U.S. equities.

The social media processing engine 108a selects a workflow action item based upon the above-described analysis that relates to initiation of a stock trade to buy Ford shares for the customer's investment portfolio. The social media processing engine 108a populates the workflow action item with relevant information such as customer ID, customer demographic data, customer account data, the F stock symbol, a proposed number of shares to purchase, a current price of Ford stock, and so forth. The social media processing engine 108a transmits the populated workflow action item to the workflow processing engine 108b.

Upon receipt of the populated action item, the workflow processing engine 108b determines that the organization's CRM system 312a and the organization's customer account trading system 312b can perform workflow transactions that are responsive to the action item (i.e., can contact the customer to advise him of the opportunity to purchase Ford stock and to pre-fill a trade ticket with a proposed trade to purchase the stock). The workflow processing engine 108b executes the workflow action item to generate transaction workflow requests for each of the CRM system 312a and the customer account trading system 312b. In some embodiments, the workflow processing engine 108b translates the workflow action item into platform-specific transaction workflow requests that can be received, accepted, and processed by the respective systems 312a, 312b without any additional analysis by those systems.

The workflow processing engine 108b transmits the transaction workflow requests to the respective systems 312a, 312b. The CRM system 312a initiates a customer contact transaction to send the customer an email detailing the stock purchase opportunity and including a link to his investment portfolio account portal (or including the contact information for an account representative at the organization). In some embodiments, the CRM system 312a also transmits an alert to the account representative at client device 114 indicating that the representative should reach out to the customer and see whether he is interested in purchasing the Ford stock.

The customer account trading system 312b initiates a trading transaction to pre-fill a trade ticket with the information necessary to execute the proposed purchase of Ford stock into the customer's account so that, upon accessing the account portal, the customer can quickly view the particulars of the trade and submit the trade for processing. In some embodiments, the customer can opt to have such trades automatically execute based upon a predefined customer profile, or can transmit approval to execute the trade via other means (e.g., text message) without requiring access to a portal.

Use Case 2

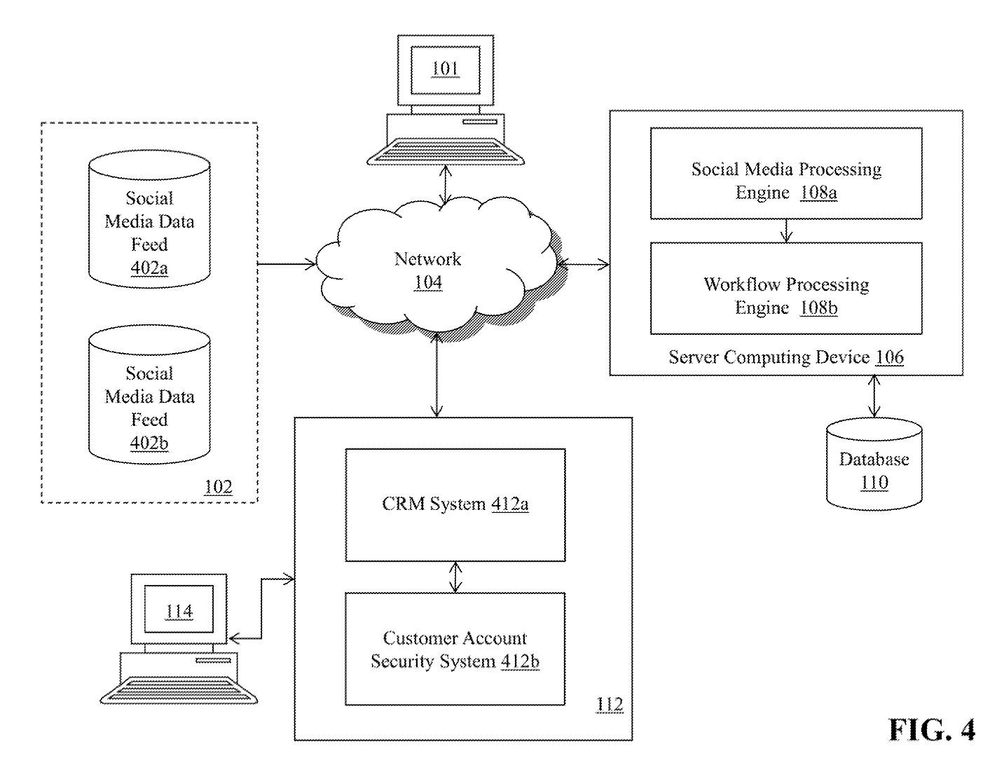

FIG. 4 is a block diagram of a system for generating and executing customer service management and account security workflow action items, based upon the system 100 of FIG. 1. In this use case, the customer at client device 101 has just posted a life event status update via her Facebook account that she is now divorced. The social media processing engine 108a receives the status update via social media data feed 402b and parses the status update to extract certain relevant information, such as the Facebook account name and the details of the status update.

The social media processing engine 108a analyzes the status update to obtain content characteristics. For example, the engine 108a identifies the word “divorce” in the status update. The engine 108a also retrieves customer profile information from database 110 and determines that the customer has a spouse listed in her profile. The engine 108a further retrieves customer account information from database 110 and determines that the spouse currently has login access to the customer's investment portal and has the ability to authorize transactions against the customer's personal investment accounts.

The social media processing engine 108a selects a workflow action item based upon the above-described analysis that relates to initiation of a process to restrict the spouse from logging into the portal and removing the ability for the spouse to authorize transactions against the customer's personal accounts. The social media processing engine 108a populates the workflow action item with relevant information such as customer ID, customer demographic data, customer account data, the spouse's login credentials, and so forth. The social media processing engine 108a transmits the populated workflow action item to the workflow processing engine 108b.

Upon receipt of the populated action item, the workflow processing engine 108b determines that the organization's CRM system 412a and the organization's customer account security system 412b can perform workflow transactions that are responsive to the action item (i.e., can update the customer's CRM profile and contact the customer to advise her to update her relevant investment account information, and update the customer's account security profile to restrict access to the spouse). The workflow processing engine 108b executes the workflow action item to generate transaction workflow requests for each of the CRM system 412a and the customer account security system 412b. In some embodiments, the workflow processing engine 108b translates the workflow action item into platform-specific transaction workflow requests that can be received, accepted, and processed by the respective systems 412a, 412b without any additional analysis by those systems.

The workflow processing engine 108b transmits the transaction workflow requests to the respective systems 412a, 412b. The CRM system 412a initiates an update transaction to the marital status on the customer's CRM profile to indicate that she is divorced. In some embodiments, the CRM system 412a also transmits an alert to the account representative at client device 114 indicating that the representative should reach out to the customer and see whether she needs any financial, legal, or other types of assistance in going through the divorce process.

The customer account security system 412b initiates a security transaction to restrict access to the spouse. For example, the customer account security system 412b can update security permissions in the customer's and/or the spouse's authentication credential profile to lock out the spouse from access to online services. The customer account security system 412b can also update the authorization parameters associated with transactions against the customer's personal accounts to remove the spouse's authorization. The customer account security system 412b can also transmit an email to the customer advising her of these changes and asking whether the changes should remain in place. In some embodiments, the customer account security system 412b can request the customer's permission to update the security permissions before actually implementing the changes.

Other Exemplary Use Cases

The following are other examples of how the systems and methods described herein can be utilized to generate and execute computer system workflow action items based upon analysis of customer social media activity.

A customer may submit a series of search engine queries, and the social media processing engine 108a can obtain the search queries via API, derive the customer's search patterns, and extract useful keywords from the search queries to determine workflow action items. For example, the customer may be submitting searches with the words “Florida vacation homes.” The engine 108a can select a workflow action item to generate a workflow transaction requests to the organization's CRM system that will contact the customer regarding real estate listings in Florida. The engine 108a can also analyze the customer's financial wealth information in the organization's wealth management system to determine a proposed price range for a vacation home that would fit within the customer's means and select a workflow action item to generate a workflow transaction request that would pre-fill a mortgage preapproval application for the customer.

A customer may post a video of his children competing in a youth classical music talent competition on YouTube. The social media processing engine 108a can analyze the video to extract content characteristics such as the type of music, the status of the child's performance (e.g., did he win?), and so forth. In some embodiments, the video is tagged with metadata (e.g., labels, keywords, and the like) that augment and/or verify the video's content characteristics that are extracted by the social media processing engine 108a. Also, the social media processing engine 108a can analyze other social media data relating to the video, such as comments on the video that have been posted by others. The engine 108a can select a workflow action item to generate a workflow transaction request to the organization's CRM system that will contact the customer with opportunities regarding saving for private school tuition. The engine 108a can also select a workflow action item to generate a workflow transaction request to the organization's educational savings account system to establish an educational savings account for the customer and select a suggested monthly savings amount that fits within the customer's budget.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

1. A computerized method for generating and executing computer system data security workflow action items based upon analysis of customer social media activity, the method comprising
receiving, by a social media processing engine of a server computing device, social media activity data from each of a plurality of social media data sources;
identifying, by the social media processing engine, an existing customer associated with a portion of the social media activity data, including
parsing the portion of the social media activity data to extract one or more social media account names and determining whether the social media account names correspond to the existing customer, and
analyzing demographic information contained in the portion of the social media activity data to determine a match with demographic information for the existing customer that is contained in a customer profile database;
selecting, by the social media processing engine, a data security workflow action item based upon an indication of potential unauthorized access to secure customer information contained in the portion of the social media activity data for the identified customer;
retrieving, by the social media processing engine, customer profile data and customer account data for the data security workflow action item based upon the identified customer;
populating, by the social media processing engine, the data security workflow action item with the customer profile data and the customer account data;
transmitting, by the social media processing engine, the populated data security workflow action item to a workflow processing engine;
executing, by the workflow processing engine of the server computing device, the populated data security workflow action item to transmit a transaction workflow request to an enterprise computing system that is responsive to the workflow action item, including translating the populated data security workflow action item into platform-specific programmatic instructions that comprise the transaction workflow request; and
modifying, by the enterprise computing system, an authentication credential profile associated with the identified customer based upon the transaction workflow request to restrict access to customer-specific data and online transaction services for one or more other customer accounts linked to the identified customer.

2. The method of claim 1, wherein the social media activity data is received via an application programming interface (API) between the social media processing engine and a social media data source.

3. (canceled)

4. The method of claim 1, wherein the demographic information includes sentiment data, financial data, employment data, life event data, audiovisual data, search engine query data, customer relationship management (CRM) data, and real estate data.

5. The method of claim 3, further comprising
determining a plurality of potential data security workflow action items based upon the extracted demographic information; and
selecting a data security workflow action item that best matches the extracted demographic information.

6-7. (canceled)

8. The method of claim 1, wherein the social media processing engine selects a plurality of data security workflow action items based upon the portion of the social media activity data for the identified customer.

9-10. (canceled)

11. The method of claim 1, further comprising
generating, by the workflow processing engine, a report associated with the received data security workflow action item; and
transmitting, by the workflow processing engine, the report to a remote client device for display.

12. The method of claim 11, wherein the report comprises an alert to a customer service representative to take a data security action based upon the data security workflow action item.

13. (canceled)

14. The method of claim 1, wherein the one or more social media account names are provided by the customer when establishing a customer profile.

15. A system for generating and executing computer system data security workflow action items based upon analysis of customer social media activity, the system comprising
a social media processing engine of a server computing device, the social media processing engine configured to
receive social media activity data from each of a plurality of social media data sources;
identify an existing customer associated with a portion of the social media activity data, including
parsing the portion of the social media activity data to extract one or more social media account names and determining whether the social media account names correspond to the existing customer, and
analyzing demographic information contained in the portion of the social media activity data to determine a match with demographic information for the existing customer that is contained in a customer profile database;
select a data security workflow action item based upon an indication of potential unauthorized access to secure customer information contained in the portion of the social media activity data for the identified customer;
retrieve customer profile data and customer account data for the data security workflow action item based upon the identified customer; and
populate the data security workflow action item with the customer profile data and the customer account data; and
a workflow processing engine of a server computing device, the workflow processing engine coupled to the social media processing engine and configured to
receive the populated data security workflow action item from the social media processing engine; and
execute the populated data security workflow action item to transmit a transaction workflow request to an enterprise computing system that is responsive to the workflow action item, including translating the populated data security workflow action item into platform-specific programmatic instructions that comprise the transaction workflow request;
the enterprise computing system being configured to modify an authentication credential profile associated with the identified customer based upon the transaction workflow request to restrict access to customer-specific data and online transaction services for one or more other customer accounts linked to the identified customer.

16. The system of claim 15, wherein the social media activity data is received via an application programming interface (API) between the social media processing engine and a social media data source.

17. (canceled)

18. The system of claim 15, wherein the demographic information includes sentiment data, financial data, employment data, life event data, audiovisual data, search engine query data, customer relationship management (CRM) data, and real estate data.

19. The system of claim 15, wherein the social media processing engine is further configured to
determine a plurality of potential data security workflow action items based upon the demographic information; and
select a data security workflow action item that best matches the demographic information.

20-21. (canceled)

22. The system of claim 15, wherein the social media processing engine is configured to select a plurality of data security workflow action items based upon the portion of the social media activity data for the identified customer.

23-24. (canceled)

25. The system of claim 15, wherein the workflow processing engine is further configured to
generate a report associated with the received data security workflow action item; and
transmit the report to a remote client device for display.

26. The system of claim 25, wherein the report comprises an alert to a customer service representative to take a data security action based upon the data security workflow action item.

27. (canceled)

28. The system of claim 27, wherein the one or more social media account names are provided by the customer when establishing a customer profile associated with the customer.

29. A computer program product, tangibly embodied in a non-transitory computer readable storage device, for generating and executing computer system data security workflow action items based upon analysis of customer social media activity, the computer program product comprising instructions operable to cause a social media processing engine of a server computing device to
receive social media activity data from each of a plurality of social media data sources;
identify an existing customer associated with a portion of the social media activity data, including
parsing the portion of the social media activity data to extract one or more social media account names and determining whether the social media account names correspond to the existing customer, and
analyzing demographic information contained in the portion of the social media activity data to determine a match with demographic information for the existing customer that is contained in a customer profile database;
select a data security workflow action item based upon an indication of potential unauthorized access to secure customer information contained in the portion of the social media activity data for the identified customer;
retrieve customer profile data and customer account data for the data security workflow action item based upon the identified customer; and
populate the data security workflow action item with the customer profile data and the customer account data;
wherein the computer program product comprises further instructions operable to cause a workflow processing engine of a server computing device coupled to the social media processing engine to
receive the populated workflow action item from the social media processing engine; and
execute the populated data security workflow action item to transmit a transaction workflow request to an enterprise computing system that is responsive to the workflow action item, including translating the populated data security workflow action item into platform-specific programmatic instructions that comprise the transaction workflow request;
the enterprise computing system being configured to modify an authentication credential profile associated with the identified customer based upon the transaction workflow request to restrict access to customer-specific data and online transaction services for one or more other customer accounts linked to the identified customer.
